(19) United States
(12) Patent Application Publication
(10) Pub. No.: US 2013/0128698 A1
(43) Pub. Date: May 23, 2013

(54) Object Outline Measuring System

(71) Applicants: Yin-Hui Lee, Hsin-Chu City (TW); Yen-Min Chang, Hsin-Chu City (TW)

(72) Inventors: Yin-Hui Lee, Hsin-Chu City (TW); Yen-Min Chang, Hsin-Chu City (TW)

(21) Appl. No.: 13/562,249

(22) Filed: Jul. 30, 2012

(30) Foreign Application Priority Data
Nov. 22, 2011 (TW) 100142692

(51) Int. Cl. G01S 15/89; G01B 11/30

(52) U.S. Cl. 367/99; 356/601

(57) ABSTRACT

A plurality of sensors are utilized for continuously detecting a plurality of relative distances between a surface of an object and the plurality of sensors within a predetermined space, and are utilized for generating a plurality of distance data according to the plurality of relative distances. A data processing module is utilized for establishing an object outline model of the object according to the plurality of distance data. Therefore, resolution or accuracy of the object outline model generated by measuring an outline of the object can be significantly increased.

### BACKGROUND OF THE INVENTION

1. Field of the Invention

The present invention discloses an object outline measuring system, and more particularly, an object outline measuring system for continuously detecting relative distances between a plurality of sensors and a surface of an under-test object within a predetermined space to establish an outline model of the under-test object.

2. Description of the Prior Art

In fitness management, consumers always care about their body shape, i.e. their outline, more than their health. However, detailed data about one's outline cannot be substantially retrieved, whereas rough data about one's outline may be retrieved by taking measurements using a tape measure by hand. However, because of the difficulty of strictly controlling artificial factors, the measurements taken may introduce large variances.

During an anaplasty, data management about the facial shape or the body shape is important. However, the required data about the body/facial shape of the patient are often retrieved using tape measurements by nurses, and as a result, differences between data before and after the anaplasty are utilized for convincing the patient of the effectiveness of the anaplasty. However, because of the above-mentioned artificial factors, significant variances may still be introduced while taking measurements of the patient.

While making tailor-made costumes, the body shape of a customer is measured by a tailor using a tape measurement for retrieving rough body-shape data to make a customized costume. However, since there may be significant variances on a partial shape between two regions of different customers, even if both the regions have had measurements taken by the tailor, there may still be certain unexpected variances on the partial shape that result in repeated alterations of the customized costume, and result in waste of much time and capital. This kind of phenomenon also happens in fitness care or anaplasties.

Besides, health care of feet or related to standing posture often faces a bottleneck in how to choose appropriate shoes for fitting feet of customers. Under the condition that feet outline of the customer cannot be retrieved in detail, the customer may merely try shoes of different types or sizes to pick out his/her shoe; however, picking out the shoe by the customer is likely to be time-consuming, and the picked-out shoe may not really fit the feet of the customer who is in lack of shoe-related professional knowledge.

### SUMMARY OF THE INVENTION

The claimed invention discloses an object outline measuring system. The object outline measuring system comprises a plurality of sensors, a carrier, and a data processing module. Anyone of the plurality of sensors is configured to continuously detect a plurality of relative distances between itself and a surface of an under-test object located within a predetermined space, and to generate a plurality of distance data according to the plurality of relative distances. The carrier is utilized for loading and fixing the plurality of sensors. The data processing module is utilized for establishing an outline model of the under-test object according to the plurality of distance data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-2 illustrate object outline measuring systems according to embodiments of the present invention.

### DETAILED DESCRIPTION

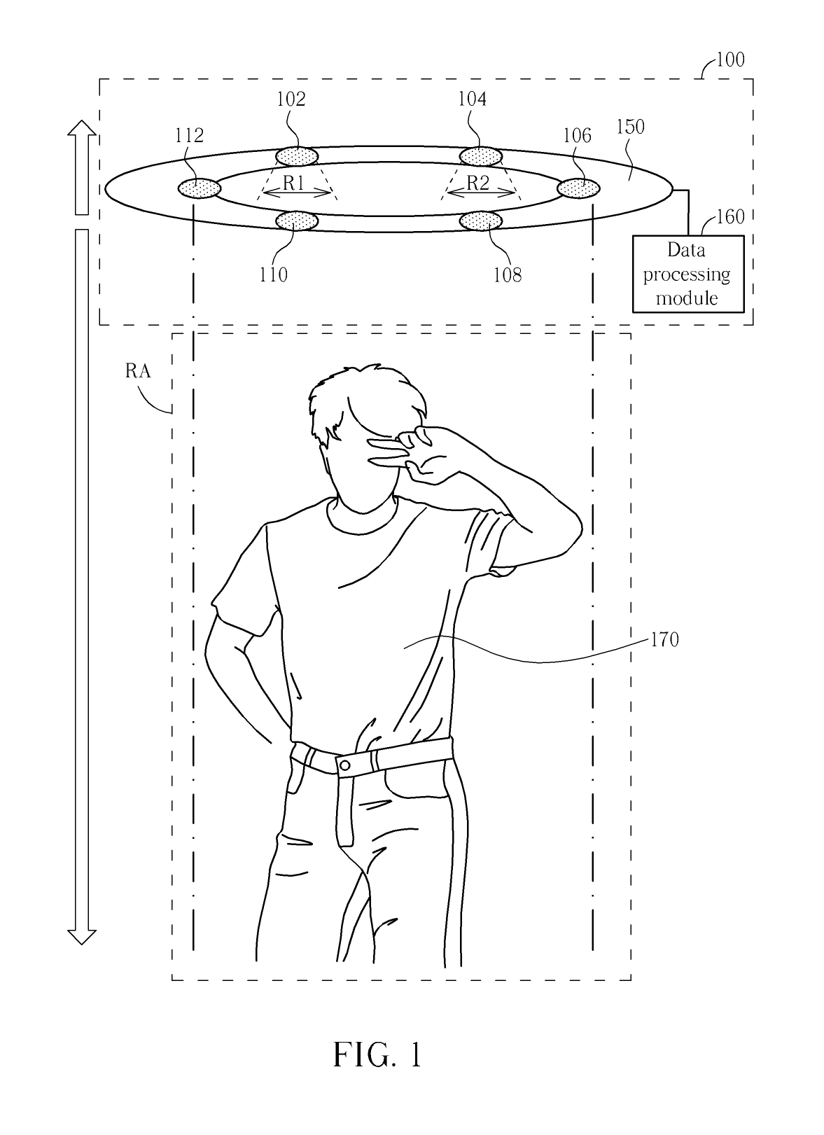

Please refer to FIG. 1, which illustrates an object outline measuring system 100 according to a first embodiment of the present invention. As shown in FIG. 1, the object outline measuring system 100 includes a plurality of sensors 102, 104, 106, 108, 110, 112, a ring-shaped carrier 150, and a data processing module 160.

The carrier 104 is utilized for loading and fixing the sensors 102, 104, 106, 108, 110, and 112, so that relative positions between the sensors 102, 104, 106, 108, 110, and 112 can be fixed. Each of the plurality of sensors 102-112 is configured to continuously detect a plurality of relative distances between itself and a surface of an under-test object 170, and is further configured to generate a distance datum according to the plurality of relative distances. The under-test object 170 is located within a predetermined space that the sensors 102-112 are capable of detecting. In the embodiment shown in FIG. 1, the under-test object 170 is a human body, however, in other embodiments of the present invention, the under-test object 170 may also be objects other than the human body. The data processing module 160 is utilized for establishing an outline model of the under-test object 170 according to a plurality of distance data generated by the sensors 102-112.

As shown in FIG. 1, the sensors 102-112 acquire different fields of view. For clarity, merely a detecting field R1 monitored by the sensor 102 and a detecting field R2 monitored by the sensor 104 are marked in FIG. 1. An effective detecting field RA formed by the sensors 102-112 is also marked in FIG. 1. When the under-test object 170 is detected by the sensors 102-112, the under-test object 170 is covered by the effective detecting field RA. Note that a range of the effective detecting field RA illustrated in FIG. 1 merely indicates one embodiment of the present invention, and as a matter of fact, a size and a shape of the effective detecting field RA is variable in correspondence with sensitivities and types of the sensors 102-112. Besides, in one embodiment of the present invention, the fields of view of the sensors 102-112 may be partially overlapped.

How the object outline measuring system 100 generates the outline model of the under-test object 170 is described as follows. When the under-test object 170 is located within and covered by the effective detecting field RA, the sensors 102-112 start continuously detecting relative distances between portions on the surface of the under-test object 170 and the sensors 102-112, and correspondingly generate a plurality of distance data according to the detected relative distances. The plurality of distance data are then sent to the data processing module 160 for further processing, so as to establish the outline model of the under-test object 170.

In other embodiments of the present invention, the number of sensors utilized by the object outline measuring system of the present invention is not limited to FIG. 1 or the following diagrams. Moreover, if the number of utilized sensors of the object outline measuring system of the present invention is more, the accuracy of the generated object outline model will be higher.

In one embodiment of the present invention, the carrier 150 is a movable carrier, and can be moved around the under-test object 170 under the condition that the sensors 102-112 are disposed around the under-test object 170. Therefore, fields of view of the sensors 102-112 can also be moved for continuously detecting different relative distances in response to different locations of the moved carrier 150; the sensors 102-112 detect relative distances between the surface of the under-test object 170 and the sensors 102-112 in order, and generate a plurality of distance data correspondingly. As a result, the effective detecting field RA can be increased in size without utilizing more sensors, and it may still raise the accuracy of the generated object outline model.

When using different types of sensors in the object outline measuring system 100 shown in FIG. 1, the relative distances between the surface of the under-test object 170 and the sensors 102-112 are also detected according to different principles. The principles may be based on a difference between transmitted signals and reflected signals, image information, etc.

In one embodiment of the present invention, the difference between the transmitted signals and the reflected signals includes a time slot between a first moment when the sensors 102-112 transmit the transmitted signals and a second moment when the sensors 102-112 receive the reflected signals, for determining relative distances between the sensors 102-112 and the surface of the under-test object 170 according to the time slot, where the sensors 102-112 may be implemented with optical distance detectors or audio wave distance detectors. Under this situation, the relative distances between the sensors 102-112 and the surface of the under-test object 170 may be detected as follows: (1) The sensors 102-112 transmit at least one detecting signal; (2) The at least one transmitted signal is reflected by the surface of the under-test object 170 to generate at least one reflection signal; (3) The sensors 102-112 determine a plurality of relative distances between the surface of the under-test object 170 and the sensors 102-112 according to differences between the at least one detecting signal and the at least one reflection signal, and generate a plurality of distance data according to the plurality of relative distances; (4) The data processing module 160 establishes the object outline model of the under-test object 170 according to the plurality of distance data. By determining the time slot between the moment of transmitting the at least one detecting signal and the moment of receiving the at least one reflection signal, under the condition that signal velocities transmitted by the optical distance detector or the audio wave distance detector are known, the plurality of relative distances between the sensors 102-112 and the surface of the under-test object 170 can be effectively determined, so as to establish the object outline model of the under-test object 170.

In one embodiment of the present invention, image information is utilized by the sensors 102-112 for determining the relative distances between the surface of the under-test object 170 and the sensors 102-112. How to use the image information to determine the relative distances is listed as follows: (1) The sensors 102-112 fetch at least one image of the under-test object 170 using an image calibration parameter; (2) The plurality of sensors 102-112 determine a plurality of relative distances between the surface of the under-test object 170 and the sensors 102-112, and generate a plurality of distance data according to the plurality of relative distances; (3) the data processing module 160 generates the object outline model of the under-test object 170 according to the plurality of distance data. In one embodiment of the present invention, determining the plurality of relative distances is performed by measuring image depths of the at least one image using the image calibration parameter, by the sensors 102-112. The object outline model of the under-test object 170 can be determined according to the plurality of relative distances.

In one embodiment of the present invention, the carrier 150 is equipped with a portable base. Therefore, a user of the object outline measuring system 100 is able to carry the object outline measuring system 100 using the portable base, for enhancing usage of the object outline measuring system 100.

Signal transmission between the data processing module 160 and the sensors 102-112 is not limited to physical wires. In one embodiment of the present invention, all of the data processing module 160 and the sensors 102-112 are equipped with wireless transmitters; therefore, the signal transmission between the data processing module 160 and the sensors 102-112 may also be implemented in a wireless manner. That is, the data processing module 160 is capable of wirelessly receiving the plurality of distance data from the sensors 102-112.

In one embodiment of the present invention, the data processing module 160 is included by a mainframe, which may be connected to the sensors 102-112 with a wire or wirelessly. The data processing module 160 of the mainframe is capable of receiving the distance data generated by the sensors 102-112 with the wire or wirelessly.

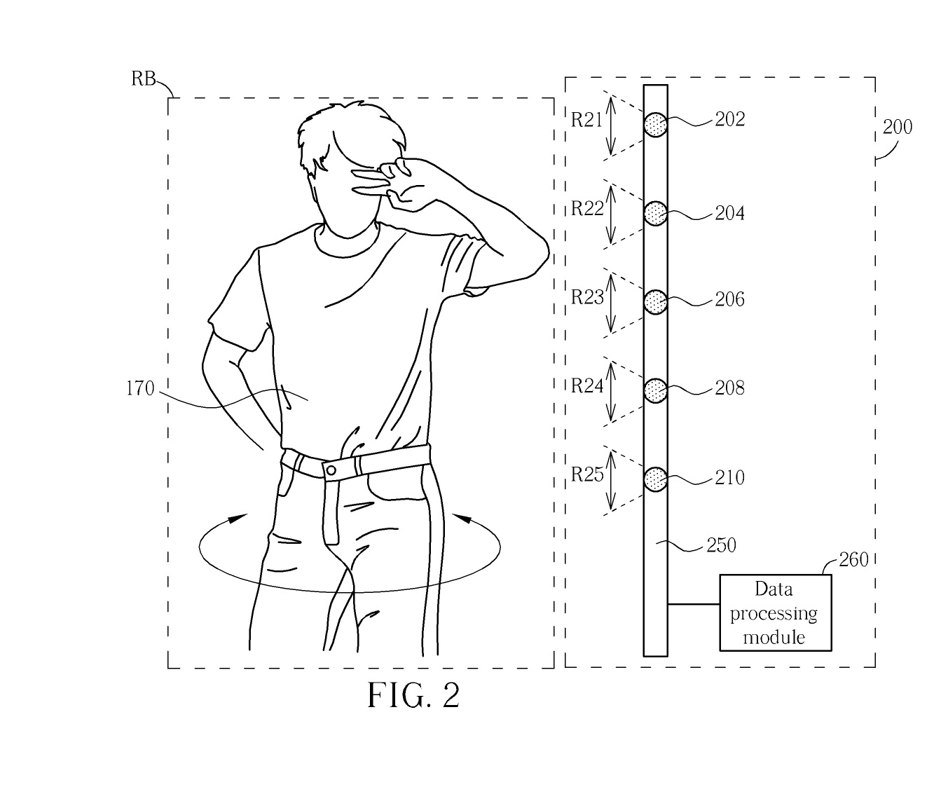

Please refer to FIG. 2, which illustrates an object outline measuring system 200 according to a second embodiment of the present invention. The object outline measuring system 200 includes a plurality of sensors 202, 204, 206, 208, 210, a bar-shaped carrier 250, and a data processing module 260. The sensors 202-210 are the same as the sensors 102-112. The carrier 250 acquires the same functions as the carrier 150. The data processing module 260 acquires similar functions as the data processing module 160. The primary difference between the object outline measuring systems 200 and 100 lies in the under-test object 170, which may be stable or may rotate. The sensors 202-210 loaded on the carrier 250 are capable of detecting a plurality of relative distances between the sensors 202-210 and the surface of the under-test object 170, and are capable of generating a plurality of distance data according to the plurality of relative distances. At least, the data processing module 260 is configured to receive the plurality of distance data and to establish an object outline module of the under-test object 170. The sensors 202-210 respectively acquire fields of view R21, R22, R23, R24, R25, and form an effective detecting field RB as a union of the fields of view R21-R25.

In one embodiment of the present invention, the sensors 202-210 may record respective representative heights as supplements in generating the plurality of distance data, similar to how a conventional tape measurement is utilized for measuring one's height.

In other embodiments of the present invention, the object outline measuring system may also be utilized for measuring curves of specific portions of the human body, and the carrier and the sensors may also be disposed for fitting the specific portions. For example, the object outline measuring system of the present invention may be utilized for measuring one's legs or feet, and the carrier and the sensors are disposed for fitting sizes of the legs or the feet; therefore, as long as a user puts his/her legs or feet into the object outline measuring system of the present invention, the object outline model of the legs or the feet can be retrieved, and the problem of the picked-up shoe which does not fit the legs or the feet can be avoided.

Note that embodiments formed by adding limitations mentioned in FIG. 1 to the embodiment shown in FIG. 2 are still embodiments of the present invention. Besides, fields of view R21-R25 may be partially overlapped.

In the above-mentioned embodiments, a reference object having a known shape and a known size may also be disposed in the effective detecting field mentioned above in advance; therefore, while using the object outline measuring system of the present invention, the reference object may be detected by the sensors of the object outline measuring system in advance to generate a criterion outline model, for calibrating the object outline measuring system of the present invention.

With the aid of the object outline measuring system of the present invention, outlines of various objects can be generated when the objects are disposed within an effective detecting field of sensors of the object outline measuring system. While a human body is to be detected by the object outline measuring system of the present invention, a precise human outline model can be established. As a result, accuracy of tasks requiring detailed information of a human body, such as anaplasties, making customized costumes, or fitting care, can be significantly raised.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An object outline measuring system, comprising:
a plurality of sensors, any one of which is configured to continuously detect a plurality of relative distances between itself and a surface of an under-test object located within a predetermined space, and to generate a plurality of distance data according to the plurality of relative distances;
a carrier, for loading and fixing the plurality of sensors; and
a data processing module, for establishing an outline model of the under-test object according to the plurality of distance data.

2. The object outline measuring system of claim 1, wherein the carrier is a movable carrier disposed around the under-test object so as to be moved around the under-test object, and the plurality of sensors are configured to detect relative distances between said plurality of sensors and the surface of the under-test object in order.

3. The object outline measuring system of claim 1, wherein the carrier comprises a base for rendering said carrier to be portable.

4. The object outline measuring system of claim 1, wherein the plurality of sensors are configured to transmit at least one sensing signal, to sense at least one reflection signal generated in response to at least one sensing signal reflected by the surface of the under-test object, and generate the plurality of distance data according to differences between the at least one reflection signal and the at least one transmitted sensing signal.

5. The object measuring system of claim 4, wherein the plurality of sensors comprise an optical sensor or a sound-wave sensor.

6. The object outline measuring system of claim 1, wherein the plurality of sensors comprise an image sensor having an image calibration parameter related to distances, and the data processing module is configured to establish the outline model of the under-test object according to both an image information generated by the image sensor and the image calibration parameter.

7. The object outline measuring system of claim 1, wherein the data processing module is connected to the plurality of sensors wirelessly, for receiving the plurality of distance data generated by the plurality of sensors.

8. The object outline measuring system of claim 1, wherein the data processing module is comprised by a mainframe.

9. The object outline measuring system of claim 1, wherein the plurality of sensors are disposed in a manner that the plurality of sensors have different fields of view.

10. The object outline measuring system of claim 9, wherein the different fields of view of the plurality of sensors are partially overlapped.

11. The object outline measuring system of claim 1, further comprising a reference object having a known outline and disposed within the predetermined space, wherein the plurality of sensors are further configured to detect the reference object, and the data processing module is further utilized for establishing a criterion outline model of the reference object for calibrating the object outline measuring system.

12. The object outline measuring system of claim 1, wherein the carrier and the plurality of sensors are disposed for matching the outline of the under-test object.
